(19) United States
(12) Patent Application Publication
(10) Pub. No.: US 2006/0238669 A1
(43) Pub. Date: Oct. 26, 2006

(54) Liquid crystal display supporting assembly

(76) Inventor: Sun Hong Chiang, Taoyuan City (TW)

Correspondence Address: CHARLES E. BAXLEY, ESQ., 90 JOHN STREET, THIRD FLOOR, NEW YORK, NY, 10038, US

(21) Appl. No.: 11/080,188

(22) Filed: Mar. 15, 2005

(51) Int. Cl. G02F 1/1333

(52) U.S. Cl. 349/58

(57) ABSTRACT

A liquid crystal display supporting device includes a base panel, a cover panel, a supporting frame disposed between the base panel and the cover panel and having a space to receive an LCD plate, for allowing the LCD plate to be stably and firmly secured and supported between the base panel and the cover panel. The supporting frame includes two beams, and two or more levers disposed and secured between the beams, to form the space of the supporting frame, and to stably support and secure the LCD plate in the space of the supporting frame. The beams each includes a horizontal flap and a vertical flap to form a corner portion, and to define the space between the vertical flap of the beams.

### BACKGROUND OF THE INVENTION

1. Field of the Invention

The present invention relates to a supporting assembly, and more particularly to a supporting assembly for supporting a liquid crystal display (LCD), and for shielding and/or for dissipating magnetic field or wave.

2. Description of the Prior Art

Typical liquid crystal displays or supporting assemblies for liquid crystal displays comprise a front panel and a rear panel, and an LCD plate disposed and secured between the front panel and the rear panel. For example, U.S. Pat. No. 5,030,128 to Herron et al. discloses one of the typical liquid crystal display supporting assemblies and also comprises an LCD plate disposed and secured between the front panel and the rear panel, and one or more printed circuit boards are rectangularly arranged surrounding the LCD plate.

However, the LCD plate is normally flexible such that the LCD plate may be easily damaged if it is not solidly or firmly secured in place. For example, when the typical liquid crystal display supporting assembly is dropped onto the ground, the LCD plate may be easily broken. In addition, the typical liquid crystal display supporting assemblies do not have any shielding devices for shielding and/or for dissipating magnetic field or wave that may be generated by the LCD plates or the typical liquid crystal display supporting assemblies.

U.S. Pat. No. 6,816,361 to Kuo discloses another typical liquid crystal display supporting assembly which also comprises an LCD plate directly disposed and secured between the front panel and the rear panel, and also has no shielding devices for shielding and/or for dissipating magnetic field or wave that may be generated by the LCD plates or the typical liquid crystal display supporting assemblies.

The present invention has arisen to mitigate and/or obviate the afore-described disadvantages of the conventional liquid crystal display supporting assemblies.

### SUMMARY OF THE INVENTION

The primary objective of the present invention is to provide a liquid crystal display supporting assembly for stably and firmly supporting the LCD plate therein.

The other objective of the present invention is to provide a liquid crystal display supporting assembly for shielding and/or for dissipating magnetic field or magnetic wave that may be generated by the LCD plate or the other elements of the liquid crystal display supporting assembly.

In accordance with one aspect of the invention, there is provided a liquid crystal display supporting assembly comprising a base panel, a cover panel, a supporting frame disposed between the base panel and the cover panel, and including a space formed therein, and an LCD plate received in the space of the supporting frame, for being stably and firmly secured and supported between the base panel and the cover panel, the supporting frame including two beams, and a first lever and at least one second lever disposed and secured between the beams, to form the space of the supporting frame, and to stably support the LCD plate received in the space of the supporting frame, and to shield and/or to dissipate the magnetic field or magnetic wave that may be generated by the LCD plate or the other parts or elements of the liquid crystal display supporting assembly.

The beams each includes a horizontal flap and a vertical flap formed therein, to form a corner portion between the horizontal flap and the vertical flap, and to define the space between the vertical flap of the beams. The beams are preferably arranged in parallel to each other.

The first lever and the second lever of the supporting frame each includes at least one fence extended upwardly therefrom, for engaging with the LCD plate. The fence of the first lever and the second lever includes at least one notch formed therein for receiving electric wires or cables.

The fence of the first lever and the second lever includes a height smaller than that of the vertical flaps of the beams, to define the space between the vertical flaps of the beams and the fence of the first lever and the second lever.

The first lever and the second lever of the supporting frame each further includes a second fence extended upwardly therefrom, and parallel to the fence, to define a groove between the fence and the second fence. The second fence of the first lever and the second lever includes at least one notch formed therein, and communicating with the grooves of the first lever and the second lever respectively, for receiving electric wires therein.

The beams second fence of the first lever and the second lever includes a height smaller than that of the vertical flaps of the beams, to define the space between the vertical flaps of the beams and the second fence of the first lever and the second lever.

The first lever and the second lever of the supporting frame are arranged in parallel to each other. The base panel includes a chamber formed therein, a main board disposed in the chamber of the base panel. A power unit may further be provided and disposed in the chamber of the base panel.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a liquid crystal display supporting assembly in accordance with the present invention;

FIG. 2 is a perspective view illustrating a supporting frame and an LCD of the liquid crystal display supporting assembly;

FIG. 3 is a perspective view of the supporting frame for the LCD plate of the liquid crystal display supporting assembly; and

FIG. 4 is an exploded view of the supporting frame for the LCD plate of the liquid crystal display supporting assembly.

### DETAILED DESCRIPTION OF THE PREFERRED EMBODIMENT

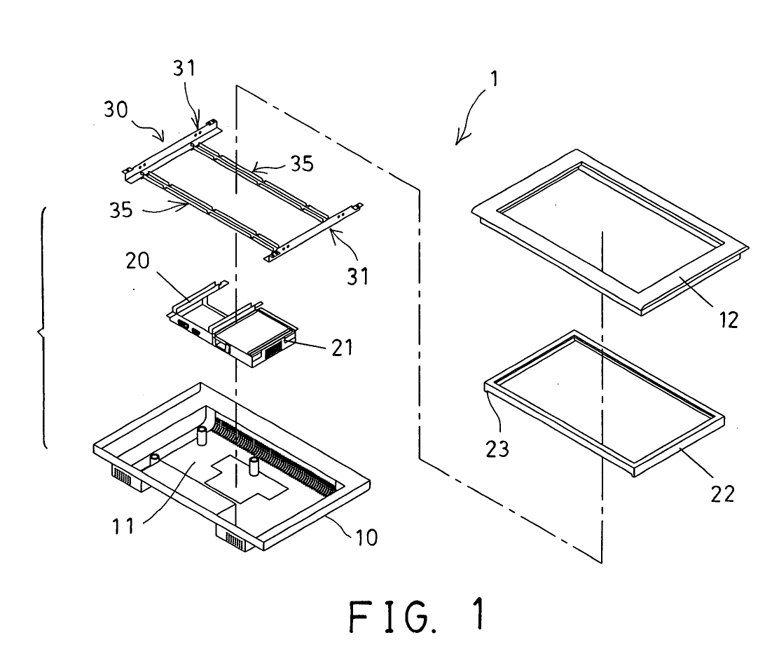

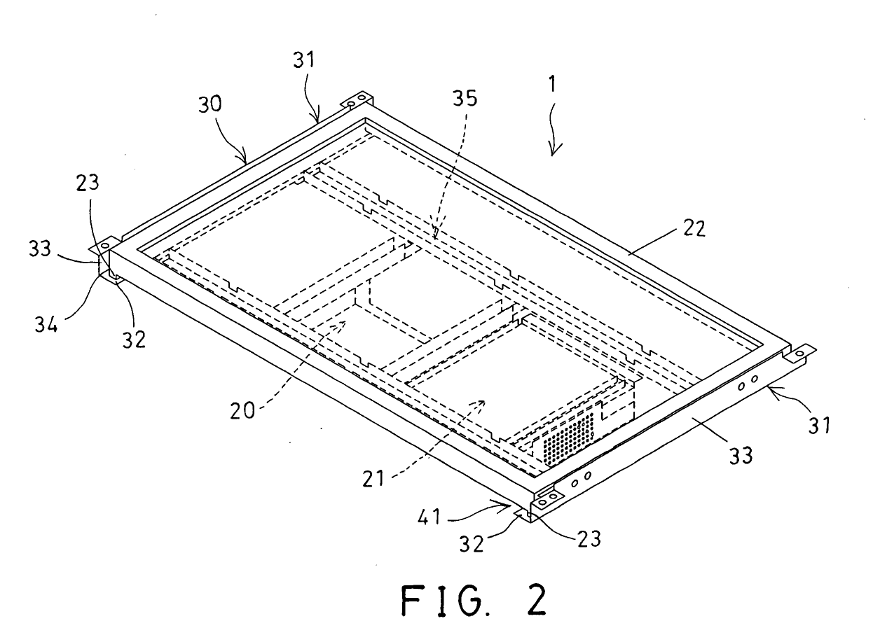

Referring to the drawings, and initially to FIGS. 1 and 2, a liquid crystal display supporting assembly 1 in accordance with the present invention comprises a rear or base panel 10 including a chamber 11 formed therein, for receiving a typical circuit board or main board 20 and/or a typical power unit 21 therein, and for receiving a supporting frame 30 therein that may be used for stably or firmly receiving and securing and supporting an LCD plate 22 therein.

The liquid crystal display supporting assembly 1 may further include an upper or cover panel 12 attached or secured on the rear or base panel 10, for stably and firmly securing and retaining and supporting the supporting frame 30 and the LCD plate 22 therebetween. The liquid crystal display supporting assembly 1 in accordance with the present invention is to provide the supporting frame 30 for stably and firmly and safely receiving and securing and supporting the LCD plate 22 therein.

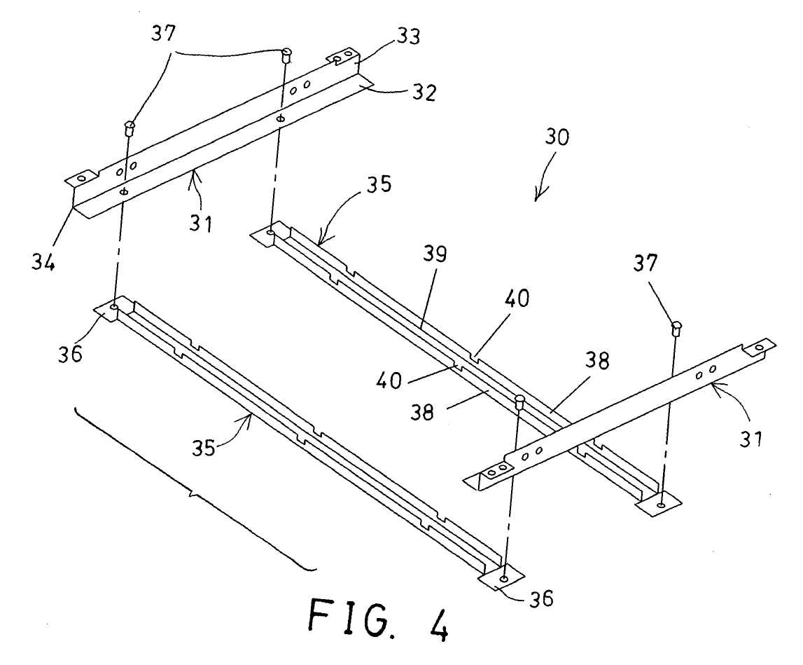

As shown in FIGS. 2-4, the supporting frame 30 includes two end or side beams 31 each having a level or horizontal flap 32 and a vertical flap 33 formed therein, and bent from such as a planar metal sheet, to form a right angle corner portion 34 between the horizontal flap 32 and the vertical flap 33. It is preferable that the beams 31 are arranged in parallel to each other. The supporting frame 30 further includes one or more, such as two levers 35 to be disposed and secured between the beams 31 and to be arranged in parallel to each other.

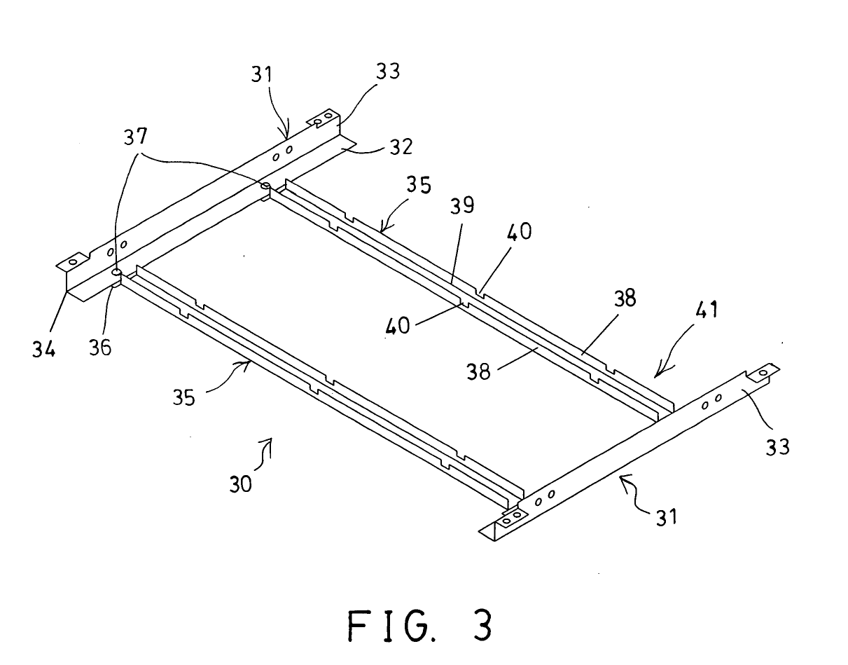

For example, each of the levers 35 includes two end portions 36 secured to the horizontal flaps 32 of the beams 31 with such as fasteners 37, in order to form a substantially square or rectangular structure or shape, best shown in FIGS. 1 and 3. Each of the levers 35 further includes one or more, such as two fences 38 extended upwardly from such as the side portions thereof, and preferably arranged in parallel to each other, to form or define a groove 39 between the fences 38, and for receiving conventional electric wires or cables (not shown) therein.

It is further preferable that each of the fences 38 of the levers 35 further includes one or more cavities or notches 40 formed therein, and communicating with the grooves 39 of the levers 35 respectively, for receiving the conventional electric wires or cables (not shown) therein, and thus for allowing the electric wires or cables to be engaged or extended out of the supporting frame 30. The supporting frame 30 may thus include a space 41 formed between the beams 31 and the levers 35, to receive the LCD plate 22 therein. The fences 38 are extended into the space 41 of the supporting frame 30.

As best shown in FIGS. 2 and 3, the fences 38 are extended upwardly from the side portions of the levers 35, and preferably include a height smaller than that of the vertical flaps 33 of the beams 31, for allowing the LCD plate 22 to be stably and firmly and solidly secured and retained between or engaged with the vertical flaps 33 of the beams 31 and the fences 38 of the levers 35, such that the LCD plate 22 may be in line contact with the vertical flaps 33 of the beams 31 and the fences 38 of the levers 35, but not in planar contact with the vertical flaps 33 of the beams 31 and the fences 38 of the levers 35.

It is preferable that the LCD plate 22 includes two or more legs or projections 23 extended downwardly therefrom (FIGS. 1, 2), such as extended downwardly from the end or side portions or from the corner portions thereof, for engaging with the horizontal flaps 32 of the beams 31, and thus for allowing the LCD plate 22 to be further stably and firmly and solidly secured and retained between the beams 31 and the levers 35. It is preferable that the legs or projections 23 of the LCD plate 22 includes a height equals to that of the fences 38 of the levers 35, for allowing the LCD plate 22 to be further stably and firmly and solidly secured and retained between the beams 31 and the levers 35.

The beams 31 and the levers 35 are preferably made of metal or other materials that may shield or absorb or dissipate magnetic field or magnetic wave that may be generated by the LCD plate or the circuit board or main board 20 or the power unit 21 of the liquid crystal display supporting assembly, for shielding and/or for dissipating magnetic field or magnetic wave, and for preventing the magnetic field or magnetic wave from hurting or interfering people or users.

Accordingly, the liquid crystal display supporting assembly in accordance with the present invention may be provided for stably and firmly supporting the LCD plate therein, and for shielding and/or for dissipating magnetic field or magnetic wave that may be generated by the LCD plate or the liquid crystal display supporting assembly.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A liquid crystal display supporting assembly comprising:
a base panel,
a cover panel,
a supporting frame disposed between said base panel and said cover panel, and including a space formed therein, and
an LCD plate received in said space of said supporting frame, for being stably and firmly secured and supported between said base panel and said cover panel,
said supporting frame including two beams, and a first lever and at least one second lever disposed and secured between said beams, to form said space of said supporting frame, and to stably support said LCD plate received in said space of said supporting frame.

2. The liquid crystal display supporting assembly as claimed in claim 1, wherein said beams each includes a horizontal flap and a vertical flap formed therein, to form a corner portion between said horizontal flap and said vertical flap, and to define said space between said vertical flap of said beams.

3. The liquid crystal display supporting assembly as claimed in claim 1, wherein said beams are arranged in parallel to each other.

4. The liquid crystal display supporting assembly as claimed in claim 1, wherein said first lever and said at least one second lever of said supporting frame each includes at least one fence extended upwardly therefrom, for engaging with said LCD plate.

5. The liquid crystal display supporting assembly as claimed in claim 4, wherein said at least one fence of said first lever and said at least one second lever includes at least one notch formed therein.

6. The liquid crystal display supporting assembly as claimed in claim 4, wherein said beams each includes a horizontal flap and a vertical flap formed therein, said at least one fence of said first lever and said at least one second lever includes a height smaller than that of said vertical flaps of said beams, to define said space between said vertical flaps of said beams and said at least one fence of said first lever and said at least one second lever.

7. The liquid crystal display supporting assembly as claimed in claim 4, wherein said first lever and said at least one second lever of said supporting frame each further includes a second fence extended upwardly therefrom, and parallel to said at least one fence, to define a groove between said at least one fence and said second fence.

8. The liquid crystal display supporting assembly as claimed in claim 7, wherein said second fence of said first lever and said at least one second lever includes at least one notch formed therein, and communicating with said grooves of said first lever and said at least one second lever respectively, for receiving electric wires therein.

9. The liquid crystal display supporting assembly as claimed in claim 7, wherein said beams each includes a horizontal flap and a vertical flap formed therein, said second fence of said first lever and said at least one second lever includes a height smaller than that of said vertical flaps of said beams, to define said space between said vertical flaps of said beams and said second fence of said first lever and said at least one second lever.

10. The liquid crystal display supporting assembly as claimed in claim 1, wherein said first lever and said at least one second lever of said supporting frame are arranged in parallel to each other.

11. The liquid crystal display supporting assembly as claimed in claim 1, wherein said base panel includes a chamber formed therein, a main board disposed in said chamber of said base panel.

12. The liquid crystal display supporting assembly as claimed in claim 11 further comprising a power unit disposed in said chamber of said base panel.
